(19) United States
(12) Patent Application Publication
(10) Pub. No.: US 2013/0230906 A1
(43) Pub. Date: Sep. 5, 2013

(54) MICROFLUID CARTRIDGE FOR MOLECULAR DIAGNOSTICS

(71) Applicants: Lucio Martinelli, Paris (FR); Marc Artigue, Noisy Sur Ecole (FR); Yann Marcy, Paris (FR); Christof Schafauer, Paris (FR)

(72) Inventors: Lucio Martinelli, Paris (FR); Marc Artigue, Noisy Sur Ecole (FR); Yann Marcy, Paris (FR); Christof Schafauer, Paris (FR)

(73) Assignee: Genewave, Evry (FR)

(21) Appl. No.: 13/885,507

(22) PCT Filed: Nov. 16, 2011
(86) PCT No.: PCT/FR11/52667

§ 371 Date: May 15, 2013

(30) Foreign Application Priority Data
Nov. 16, 2010 (FR) 1059425

(51) Int. Cl. G01N 1/28

(52) U.S. Cl. CPC G01N 1/28
USPC 435/283.1

(57) ABSTRACT

A cartridge for carrying out a method of analyzing the nucleic acids contained in a sample, includes a main body (1) produced in a substrate, in which there are formed at least one reaction chamber (6) and one detection chamber (10) for at least one nucleic acid likely to be contained in the sample, a microfluid circuit including a sample-injection member (7), elements (4 and 13) for respectively injecting fluids into and removing fluids from the cartridge, cavities, fluidic passages (2) and valves capable of closing them. The cartridge further includes (a) a first face known as the actuation face (16), from which the valves of the cartridge are actuated, and (b) a second face, opposite to the actuating face, including the detection chamber (10) for at least one nucleic acid likely to be contained in the sample, this face being known as the detection face (15).

The present invention relates to the microfluidic devices of the “lab-on-a-chip” type, which may integrate the complete sequence of analysis of a sample, up to the reading of the result. More precisely, the device according to the present invention is a cartridge for performing the steps of analysis of a biological sample, typically performed in a laboratory. It comprises means for identifying target molecular markers, isolated from a biological sample. Such cartridge is adapted to be inserted into at least one device for the control of injection and microfluidic circulation, the thermal control as well as the transduction of a specific signal indicating the presence of a searched substance.

In the present application, “molecular diagnostics” is to be understood as revealing the presence in a biological sample of a nucleic acid or molecular marker whose sequence is specific of a gene of interest, or even a germ.

A molecular diagnostics may be performed in a microfluidic device of the “lab-on-a-chip” type, which integrates in a same substrate, or cartridge, whose size is generally of a few square centimeters, functional areas that allow performing complex analyses typically performed in laboratory while consuming small reactive volumes.

Microfluidic devices integrating means for processing the sample (extraction of nucleic acids from said sample and/or amplification of the target nucleic acids) and means for detecting the target nucleic acids are described for example in the documents “Current state of intellectual property in microfluidic nucleic acid analysis”, Malic et al., Recent Patents on Engineering 2007, 1, 71-88 and “Microfluidic systems for pathogen sensing”, Mairhofer et al., Sensors 2009, 9, 4807-4823.

The detection of nucleic acids may be performed by means of various techniques. Generally, the detection of target molecules is performed by implementing molecular recognition mechanisms, which indicates the presence of a searched substance by means of a detectable signal. The affinity biosensors interact through hybridization with the substance of interest. This type of sensor uses specific molecules such as antibodies, oligonucleotides, peptides or lectins. This type of biosensor is ideal within the framework of development of portable universal identification devices.

In particular, the biochip technologies based on this principle have made it possible to monitor simultaneously the expression levels of a great number of molecular markers (see for example Schena et al. 1995, Science 270:467-470; Lockart et al. 1996, Nat. Biotechnology 14:1675-1680). The DNA biochip technique is based on the principle of molecular hybridization. Such biochips essentially comprise a solid substrate or support, generally flat, on the surface of which are immobilized probe molecules, whose sequence is specific of target nucleic acids.

The localized hybridization is detected by the emission of a chromogenic signal. Herein, “chromogenic signal” is to be understood as any light signal emitted directly, or indirectly, after excitation by a suitable light source or after chemical or enzymatic transformation. Hence, are included in the category of the chromogenic signals, the colorimetric, photoluminescent, fluorescent, chemoluminescent, bioluminescent signals, or the like. Such signals are either directly emitted by the molecules of interest, or emitted by detectable elements (tags), which are added and/or grafted thereto. The most frequently used technology consists in grafting a chemical or electrostatic tag to the target molecule to be detected. The grafting of a tag (detectable element), such as a fluorophore for example (fluorescent organic molecule or inorganic nanoparticle such as the nanocrystals and quantum boxes of the quantum-dot type), may be performed by known techniques on the target molecules, before or after the immobilization thereof on the surface of the biochip. It may also occur that the detection of the molecule of interest or of the tag is indirect, requiring an additional step of development. The detectable element may also be carried by the probe molecule.

Under illumination, the surface of the biochip then emits light at a characteristic wavelength at the places where probe molecules that are marked or linked to the marked target molecules are attached.

Generally, the measurement sequence of a fluorescence-detection DNA biochip is the following: the biochip carrying a chosen set of drops (spots) of probe molecules is put into contact with the sample to be studied, which is likely to include target nucleic acid molecules in liquid phase. In controlled conditions of temperature, the target molecules will preferably hybridize with the probe molecules that are specific thereof. After hybridization of the target molecules, the biochip is washed. A fluorescence reader then allows obtaining a fluorescent image of the biochip surface. For that purpose, the biochip is illuminated with a light source at the wavelength of excitation of the fluorophore marking the target molecules, and an adapted optical system forms an image of the fluorescence of the biochip at the wavelength of emission of the fluorophores. The light intensity of each point of this image is related to the quantity of fluorophores present at the corresponding point of the biochip, which is itself proportional to the number of target molecules that have been selectively attached at this place during the hybridization phase, which makes it possible to collect information (often quantitative) about the nucleic acid content of the sample.

One of the limitations of this technique of detection is the sensitivity of the signal produced, in particular when there are few target molecules in the sample to be analyzed. To push back these limits, the microfluidic devices of the lab-on-a-chip type, based on nucleic-acid detection systems of the biochip type, thus generally integrate gene amplification means.

Gene amplification allows obtaining a significant number of copies of identical nucleic sequences. It thus allows obtaining a good sensitivity of detection from an infinitesimal initial quantity of target nucleic acid (see, for example, Future Microbiol. 2010 Feb. 5(2):191-203). The most generally used amplification technique is the Polymerase Chain Reaction, whose acronym is PCR. The PCR is performed by repeating elongation reactions in the presence of nucleotidic primers specifics of the sequence to be amplified, and of a DNA polymerase.

Within the framework of detection of target nucleic acids with a biochip, wherein several markers are generally detected simultaneously, the amplification is often made through a multiplexed PCR, wherein several nucleic acids are amplified simultaneously in a same chamber.

The microfluidic devices of the lab-on-a-chip type have many advantages with respect to the conventional techniques of molecular diagnostics in laboratory. The miniaturization and the reduction of the reaction volumes associated with the reduction of the number of external intervention have thus allowed a considerable time saving, and a significant reduction of the risks of contamination of the sample. Moreover, the integration of the analysis steps within a same device providing a final result minimizes the interventions on the sample by a human operator and thus makes this technology available to technicians who are not expert in molecular biology.

These advantages have contributed to the generalization of their use, and automatons for the reading of microfluidic cartridges have thus been developed. Nevertheless, the large-scale use of such devices, in particular within the framework of human molecular diagnostics, for which the cartridge has to be discarded after each use, is limited by the complexity and the high costs inherent in this technology. Moreover, as such devices often consist in an assembly of many elements for performing the different analysis steps, they remain extremely fragile and delicate to handle.

Therefore, despite the many developments of integrated microfluidic devices, there still exists a need for improved devices allowing the simple and cheap implementation thereof.

Complex microfluidic devices are known, which integrate the analysis steps typically performed in laboratory. They generally comprise a set of cavities connected by micro-channels, forming a network controlled by integrated microfluidic valves. Such valves are very often diaphragm valves. The diaphragm valves comprise a valve body (seat) with at least two ports (an inlet port and an outlet port, forming respectively an inlet orifice and an outlet orifice) as well as a flexible diaphragm placed opposite the valve seat, whose deflection allows blocking the valve.

A microfluidic device including diaphragm valves is disclosed in particular in the document EP 1 327 474 A1. This document describes a microfluidic device integrating a simplified system of microfluidic valve. In this device, an element (B) is connected to the surface of an element (A). Said surface of the element (A) includes grooves. The element (B) therefore cooperates with the element (A) in a such way to define, at the interface between the elements (A) and (B), a capillary flow channel. “Spaces” can be formed in these channels. Besides, the element (B) can be made in a soft material, at least in the portion opposite to the “space”, made in the capillary flow channel. The device integrates a valve function so that the selective compression of the “space”, from the element (B), allows the volume of said space to reversibly decrease.

Moreover, the document WO2009/049268 A1 describes a microfluidic device comprising several functional areas of analysis. This device integrates: a sample preparation area for extraction of the nucleic acids, an area for amplification of the nucleic acids and an area for analysis and detection of the amplified nucleic acids. Said detection area might be a biochip.

The device according to this prior art is formed by a rigid plastic substrate, on which is fixed a plastic diaphragm, itself substantially rigid. The diaphragm and the substrate are formed in materials of the thermoplastic polymer type (polymethyl methacrylate, polystyrene, polycarbonate). The thickness of the diaphragm is chosen so as to permit the deformation thereof by a suitable mechanical force. The substrate may comprise micro-elements opposite parts that are not sealed to the diaphragm, cooperating with the diaphragm to form a diaphragm valve structure.

This device is a three-layer lamellar structure, integrating the diaphragm-valve actuation system. The third layer, located on the upper face of the flexible diaphragm, allows the pneumatic control of the valves.

Although it has been progressively simplified, the design of the microfluidic devices thus remains complex.

The object of the present invention is a cartridge making it possible to perform all the steps of analysis and detection of molecular markers present in a sample, which is robust and simple.

It is therefore possible to use it as a single-use element for performing reliable tests in good economic conditions.

The cartridge according to the present invention is a device for performing a method of analysis of nucleic acids comprised in a sample, comprising a main body made in a substrate, in which are formed

at least one reaction chamber and one chamber for the detection of at least one nucleic acid likely to be contained in the sample,

a microfluidic circuit including a means for injection of the sample, means for injection and evacuation of fluids into and out of the cartridge, cavities, fluidic channels and valves capable of blocking these latter.

This cartridge is characterized in that it comprises (a) a face known as the actuation face, from which the actuation of the cartridge valves is possible, and (b) a second face, opposite to said valve actuation face, including the chamber for the detection of at least one nucleic acid likely to be contained in the sample, and known as the detection face.

The substrate of this cartridge is advantageously rigid.

The term “microfluidic” applies within the framework of the present application to systems for handling fluids including channels, at least one dimension of which is lower that the millimeter.

This cartridge is capable of being inserted into receiving stations, within apparatuses for performing the following functions: thermal control, fluidic supply and fluid circulation control, as well as optical detection.

According to a particular embodiment, the valves are formed by a deformable diaphragm placed opposite a valve seat. Said valve seat including at least one inlet orifice and one outlet orifice of said valve seat.

The inlet and outlet orifices of the valve seats correspond to ends of the fluidic channels of the cartridge.

More particularly, the valve seats are formed by recesses formed at the surface of the actuation face. By “surface of the actuation face”, it is to be understood the surface of the substrate forming the main body of the cartridge, on the side of the so-called actuation face.

Still more precisely, the surface of the deformable diaphragm, placed opposite the valve seats, is, at rest, approximately planar and parallel to the actuation face of the cartridge and capable of being deformed by an outer actuator. According to various embodiments, the deformation of the diaphragm is likely to open or block the valve.

The valve seats may be formed in such a way to define a space between the diaphragm at rest and the bottom (or floor) of the valve seat. According to this embodiment, the valves are thus in open position at rest.

Advantageously, the valve actuators might be pistons deforming the valve and blocking it. A pneumatic device for applying a pressure deforming the diaphragm opposite each valve seat may also be contemplated.

It may also be contemplated that the valve seats are formed in such a way that the diaphragm at rest blocks said valve seats. A pneumatic device for applying a negative pressure deforming the diaphragm opposite each valve seat would then allow the opening of the valves.

According to a particular embodiment, the cartridge includes fluidic channels made in the substrate forming the main body of the cartridge, in the vicinity of each of the actuation and detection faces of the cartridge. The cartridge also includes holes going through said substrate and connecting the two faces of the cartridge, or the channels in the vicinity of these latter. It is advantageous that the channels formed in the vicinity of the two faces are parallel to the actuation face of the cartridge.

More precisely, these fluidic channels located in the vicinity of the actuation and detection faces of the cartridge may be formed by grooves, made in the substrate forming the main body of the cartridge, flush with one of the surfaces of said substrate, on side of the actuation face side or on the side of the detection face. These grooves are closed by closing elements, to form fluidic channels.

According to a particular embodiment, the cartridge allows the injection of the sample as well as the injection of fluids into the cartridge, or the evacuation of fluids out of the cartridge from the detection face of said cartridge. These injections or evacuations are performed from injection or evacuation orifices located at the surface of the substrate forming the main body of the cartridge, on the side of the detection face of the cartridge. These orifices may be connected to the fluidic channels formed in the vicinity of the actuation face by through-holes.

Advantageously, the injection of fluid (including possibly the sample) into the cartridge as well as the evacuation of fluids out of the cartridge are controlled by valves of the cartridge. These valves that, as all the valves of the cartridge, are located at the surface of the rigid substrate (forming the main body of the cartridge) on the side of the actuation face, include at least:

one inlet or outlet orifice of the valve seat, opening at the center of said valve seat. This orifice is formed by an end of a hole going through the substrate, perpendicularly to the detection face. The other end of the through-hole, advantageously opening at the surface of the substrate on the side of the detection face of the cartridge, is likely to be an injection or an evacuation orifice as described above.

an outlet or inlet orifice of the valve seat, formed by an end of the fluidic channel formed in the vicinity of the actuation face of the cartridge. Advantageously, this channel is formed by a groove flush with the surface of the substrate of the cartridge, on the side of the detection face.

In valves of this type, the deformation of the diaphragm by the application of a pressure (pneumatic or via a piston) is likely to block the valve seat and more particularly the inlet or outlet orifice opening at the center thereof. This type of valve is typically open at rest.

It is advantageous, according to an embodiment, to provide so-called U-shaped valves, for stopping the circulation of fluid, within a channel formed in the vicinity of the actuation face of the cartridge. To form such a U-shaped valve, the channel parallel to the actuation face of the cartridge is offset, by means of a through-hole, to the detection face and reinjected into the actuation face by means of a second through-hole, the end of which on the side of the actuation face of the cartridge forms an orifice opening at the center of a valve seat.

According to the embodiment, an offset channel is formed in the vicinity of the detection face of the cartridge. Preferentially, according to this embodiment, said channels formed in the vicinity of the actuation face or the detection face are formed by grooves flush with either surface of the substrate on the side of the actuation face or of the detection face.

Advantageously, the elements closing the grooves formed on the detection face (opposed to the actuation face), and thus forming fluidic channels, are adhesive dots (patches), for example lamellar elements likely to be bonded on the substrate after formation of the grooves.

In valves of this type, the deformation of the diaphragm by application of a pressure (pneumatic or via a piston) is likely to block the valve seat and more particularly the inlet or outlet orifice opening at the center thereof. This type of valve is typically open at rest.

The circulation of fluid, within a channel parallel to the actuation face of the cartridge, may also be controlled according to another device, of the in-line valve type. The parallel channel according to this device is interrupted by a valve seat opposite which a deformable diaphragm is likely to be deformed. In this type of valve, the deformation of the diaphragm, by a positive or a negative pressure, is likely to block the valve seat and to close the valve, or to open said valve.

According to this last embodiment, in which the in-line valves are used, all the fluidic channels parallel to the actuation face may be advantageously located at the surface of the rigid substrate on the side of said actuation face.

According to an alternative embodiment, the reaction chamber(s) might be formed by one/several recess(es), flush with the surfaces of the rigid substrate on the side of one or each of the detection and actuation faces of the cartridge. This(these) recess(es) may be closed by a closing element.

Preferentially, the cartridge includes at least one reaction chamber for amplification of nucleic acids.

The most current amplification technique is the PCR (Polymerase Chain Reaction). This technique requires thermally cycling (generally between 50 and 95° C.) a reaction mixture. This thermal cycling is favored within the framework of a microsystem as the cartridge of the present invention, by the small reaction volumes. It is possible to displace the reaction mixture between different temperature areas, circularly or in continuous flow, or to make the thermal cycling within a single chamber that may be isolated. The PCR having been mentioned by way of example, other techniques of amplification may also be used, including the Reverse Transcriptase PCR (RT-PCR), the Rapid Amplification of cDNA Ends (RACE), the Rolling Circle Amplification (RCA), the Nucleic Acid Sequence Based Amplification (NASBA), the Transcription Mediated Amplification (TMA), the Ligase Chain Reaction. The isothermal amplification techniques may be advantageous because they are based on various enzymes that make useless the step of denaturizing the nucleic acids at 95° C. Such techniques use, for example: polymerases such as Phi29 that have an activity of strand displacement, helicases that denaturize the strands upstream a conventional polymerase, other enzymes, producing NRA as an intermediate product, itself amplified by transcription.

The cartridge according to the present invention is preferentially intended to the parallel detection of the presence of several molecular markers within a biological sample. The choice of a multiplexed amplification thus makes it possible to perform within a single reaction chamber the amplification of several target molecules of nucleic acids.

Moreover, the amplification step may allow marking the amplicons, for example by incorporating tagged nucleotides (i.e.: carrying a detectable element). The choice of the tag (detectable element) depends on the strategy of detection used. Within the framework, for example, of optical reading in light-detection molecular recognition (optical transduction), the tag may be an organic fluorophore or inorganic nanoparticles, as the quantum dots, the nanocrystals of doped rare-earth oxides, the nanoparticles of silica or the metallic nanoparticles.

According to a particular embodiment, the reaction chamber(s) might be formed at the surface of the substrate forming the main body of the cartridge on the side of the actuation face of the cartridge. In this embodiment, the chamber(s) is(are) formed by recesses made in the substrate of the cartridge and flush with the surface of the substrate on the side of the actuation face.

According to an embodiment, the cartridge includes a monolithic diaphragm, which covers all or part of the actuation face of the cartridge (i.e. the surface of the rigid substrate, on which it may, for example, be bonded or thermo-welded). According to this embodiment, said diaphragm cooperates with the surface of the rigid substrate on the side of the actuation face of the cartridge, to form channels parallel to said face, at the grooves formed on said surface, and at least one reaction chamber, at the cavity(ies) (recess) formed on said surface.

It is then advantageous that said monolithic diaphragm covering the actuation face is capable of resisting to heat and transmitting said heat.

This aspect may reveal important within the framework of thermal control of the reaction chamber(s).

Several devices of thermal cycling of the amplification chamber may be contemplated. It is possible to heat locally the reaction chamber using, for example, an infrared radiation (for example by means of a laser or a lamp). Heating devices may also be brought into contact with the PCR chamber, such as Peltier elements or platinum elements.

For that purpose, openings may be operated through the main body of the cartridge and the diaphragm, which allow in particular to reduce the thermal dispersion.

Still advantageously, this monolithic diaphragm is a deformable diaphragm, cooperating with the surface of the rigid substrate on the side of the actuation face of the cartridge, to form diaphragm valves, opposite the valve seats formed on said surface. Said diaphragm is likely to be deformed opposite each valve seat, through a pneumatic pressure or a pressure applied for example via a piston, or through a pneumatic negative pressure.

In the embodiments comprising a monolithic diaphragm as described hereinabove, said diaphragm is thus likely to fulfill a certain number of functions. Indeed, the monolithic diaphragm cooperates with (i) the rigid substrate, to form the parallel channels and to close the actuation face, and (ii) the actuation systems placed opposite the valve seats formed in the rigid substrate, for the formation of the valves and the actuation thereof. It may also ensure the transmission of heat.

The positioning and the bonding of such a diaphragm on a rigid substrate forming a microfluidic analysis device are delicate steps of manufacturing.

According to the present invention, the problems for the manufacturing of the cartridge, related in particular to the positioning of the diaphragm on the rigid substrate, are simplified. Indeed, in the cartridge according to the invention, the two opposite main faces are distinctly functionalized. In particular, one of these faces is dedicated to the actuation of all the valves. In that way, it is not necessary to perform cuts of the diaphragm before, or after, the deposition of said diaphragm on the rigid substrate forming the main body of the cartridge. Furthermore, in certain particularly preferred embodiments, the deposition of said diaphragm may cover the whole actuation face of the rigid substrate.

The detection chamber is an affinity biosensor for detecting the presence of specific target molecules in the sample. The affinity biosensors interact with the target molecule by ligation. The cartridge according to the present invention is intended to allow the detection in parallel of the presence of several molecular markers within a biological sample. The capture of the amplification products, or amplicons, on a surface is a technique that is well known of the one skilled in the art, to perform a multiplexed detection. The favorite mode of detection is the biochip.

The biochip systems are presently widely used for the detection and the measurement of specific substances in complex samples. With such a biochip, the identity and quantity of a target molecule in a sample are measured by measuring the level of association of the target sequence with probes specifically provided for said sequence. In the DNA biochip technologies, a set of probe nucleic acids, each having a defined sequence, is immobilized on a solid support or substrate in such a way that each probe occupies a predetermined position. Once the set of probes immobilized, the biochip is placed into contact with a sample in such a way that the complementary sequences can be combined with an immobilized probe, for example by hybridization, association or linking to the probe. After the elimination of the non-associated material, the associated sequences are detected and measured.

The probes are generally not marked (in other words, the probe has no detectable marker).

According to this embodiment in which the biochip detection is used, the detection and quantification of the interaction between the target molecules and the probes are performed by an optical detection device: a light radiation of a first given wavelength excites chromophores linked to the target molecules. The light emitted by the chromophores at a second wavelength, in response to their luminous excitation is then collected by a collecting device.

According to a particularly preferred embodiment, the nucleic acid detection chamber is formed by a recess formed at the surface of the substrate forming the main body of the cartridge, on the side of the detection face. This detection chamber is capable of receiving a biochip. This detection chamber may then be called the hybridization chamber. It is therefore advantageous that the biochip closes the detection chamber on the external side of the substrate forming the main body of the cartridge. The detection/hybridization chamber includes at least one inlet orifice and one outlet orifice (said orifices constituting the ends of holes going through the substrate forming the main body of the cartridge, and leading to the fluidic channels formed at the surface of said substrate on the side of the actuation face). The inlet orifice of the detection/hybridization chamber allows the entrance, for example, of the reaction mixture containing the amplicons. These amplicons are then likely to hybridize on the probe molecules that are complementary thereto.

It is also particularly advantageous that the present cartridge, and thus the reading of the biochip, is adapted to a system for collecting the light emitted by the chromophores in response to a luminous excitation of the contact imaging type.

It may be contemplated that the cartridge is intended to be placed in an apparatus for contact-imaging optical reading.

It will then be advantageous that the biochip be placed on the lower face of the cartridge. The actuation face of the valves being then formed on the upper face of the cartridge.

Advantageously, the substrate forming the main body of the cartridge is transparent. It is then possible to contemplate that the illumination of the chromophores likely to be immobilized on the surface of the biochip support is made from the upper, actuation face of the cartridge.

In case of detection of target nucleic acids by means of a fluorescence biochip, it may be advantageous that the substrate of the biochip, which is likely to comprise fluorescent substances immobilized at its surface, which absorb the light at a first, excitation wavelength and which emit light at a second, emission wavelength, comprises means for increasing the efficiency of the emission light quantity related to the excitation light quantity.

According to an embodiment, the means increasing the quantity of light emitted comprise a reflective mirror placed in the substrate at a distance (d) from the upper face, this distance (d) satisfying the relation d>nλ/2NA2 or d<nλ/2NA2.

Those aspects have been described in particular in the documents WO 02/16912 A1, WO 2007/045755 A1 and WO 2010/007233.

Finally, according to a particularly preferred embodiment, the cartridge is disposable. Indeed, the invention allows simplifying the design of said cartridge. Said cartridge comprises a rigid substrate including two opposite faces (that might be approximately parallel to each other), at the surface of which are formed grooves and cavities. The functionality of the two faces is strictly defined: all the valves are located on the same face, known as the actuation face of the valves. According to an embodiment, this face also comprises all the fluidic channels parallel to said actuation face.

The actuation face of the valves is closed by a deformable diaphragm, which also fulfills a role of diaphragm deformable at the level of the valve seats formed at the surface of the actuation face.

The substrate is also pierced with through-holes, perpendicular to the actuation face of the cartridge.

These through-channels fulfill roles of ports for injection of the fluids (and of the sample) into the cartridge and ports for evacuation of the fluids out of the cartridge, and of channels of access to the biochip.

The biochip face comprises the injection and evacuation orifices, and possibly the offset parallel channels of the U-shaped valves, and the detection chamber, which is likely to receive a biochip, on the external side of the substrate forming the main body of the cartridge. The biochip thus also fulfills the role of sealed closure of detection chamber.

The offset parallel channels may be closed by a closing element.

This cartridge is intended to be inserted into at least one automaton for providing the functions of fluidic circulation control, thermal cycling and optical detection. Such devices, which may with no inconvenience be used several times, may be very complex. The present invention aims to provide a cartridge making it possible to fulfill all the steps of analysis of a biological sample but whose design is ultra-simplified so as to obtain a robust consumable object, with reduced manufacturing costs.

The detailed description of particular embodiments of the invention will be made with reference to the drawings, in which:

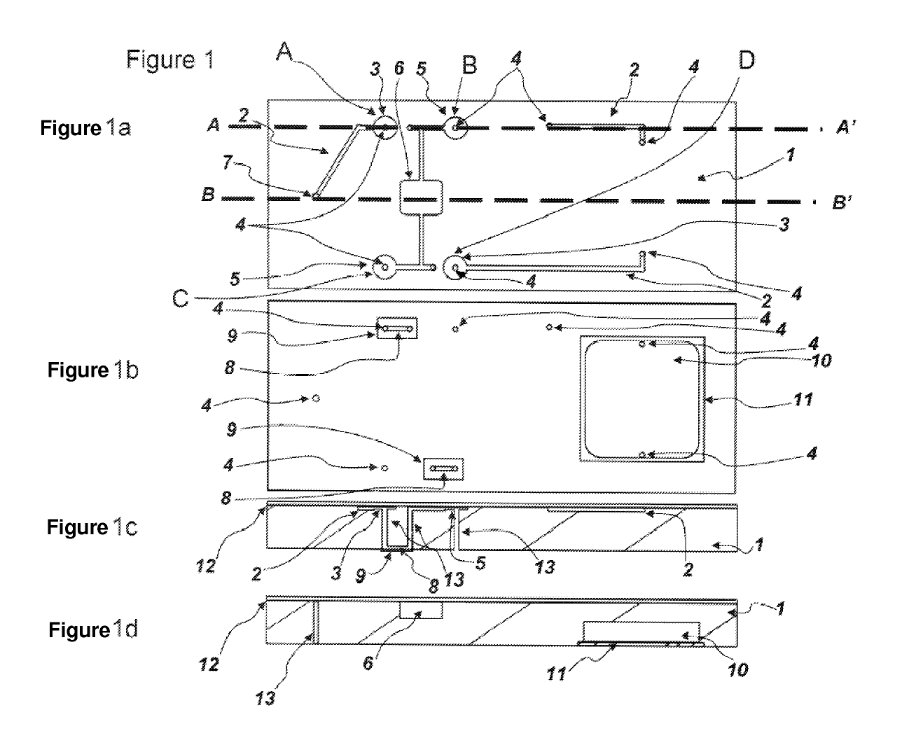

FIG. 1a is a schematic view of the actuation face of the cartridge according to an embodiment comprising U-shaped valves.

This diagram illustrates the substrate forming the main body of the cartridge 1, the microfluidic channels parallel to the actuation face 2, U-shaped valve seats 3, orifices formed by the ends of through-holes 4, fluidic injection or evacuation valve seats 5, a reaction chamber 6.

FIG. 1b is a schematic view of the detection face of the cartridge according to an embodiment. It illustrates in particular the sample injection orifice 7, offset fluidic channels 8 of the U-shaped valves, elements 9 for closing said channels, the detection chamber 10, the biochip 11.

FIG. 1c is a schematic sectional view, according to the axis AA′, of the cartridge according to an embodiment. It illustrates in particular the deformable diaphragm covering the actuation face of the cartridge 12, and the through-holes 13.

FIG. 1d is a schematic sectional view, according to the axis BB′, of the cartridge according to an embodiment.

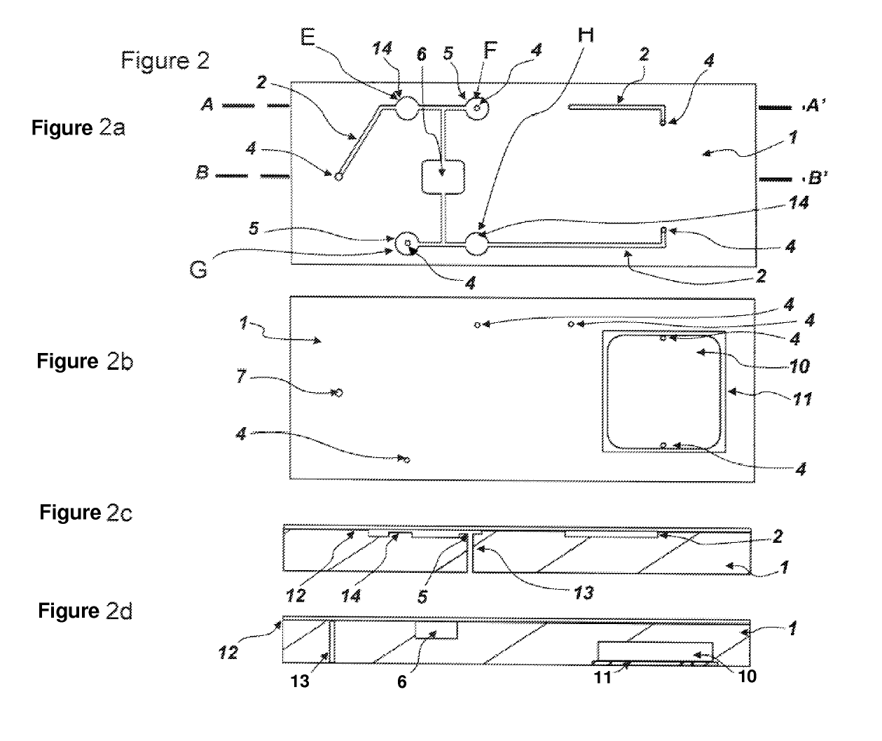

FIG. 2a is a schematic view of the actuation face of the cartridge according to an embodiment different from the embodiment of FIG. 1. It illustrates in particular the in-line valve seats 14.

FIG. 2b is a schematic view of the detection face of the cartridge.

FIG. 2c is a schematic sectional view, according to the axis AA′, of the cartridge according to an embodiment.

FIG. 2d is a schematic sectional view, according to the axis BB′, of the cartridge.

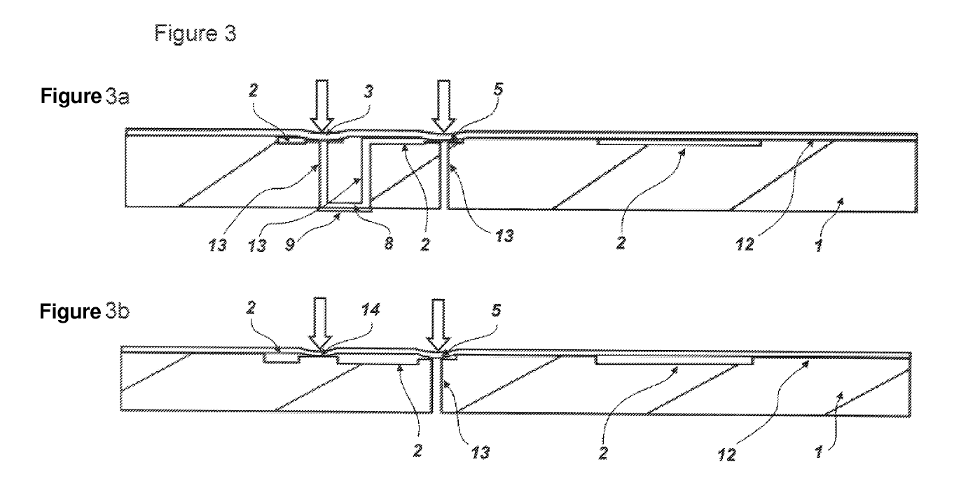

FIGS. 3a and 3b are schematic sectional views, according to the axis BB′, of the cartridge according to the embodiments of FIGS. 1 and 2, respectively, illustrating the deformation of the diaphragm opposite the valve seats.

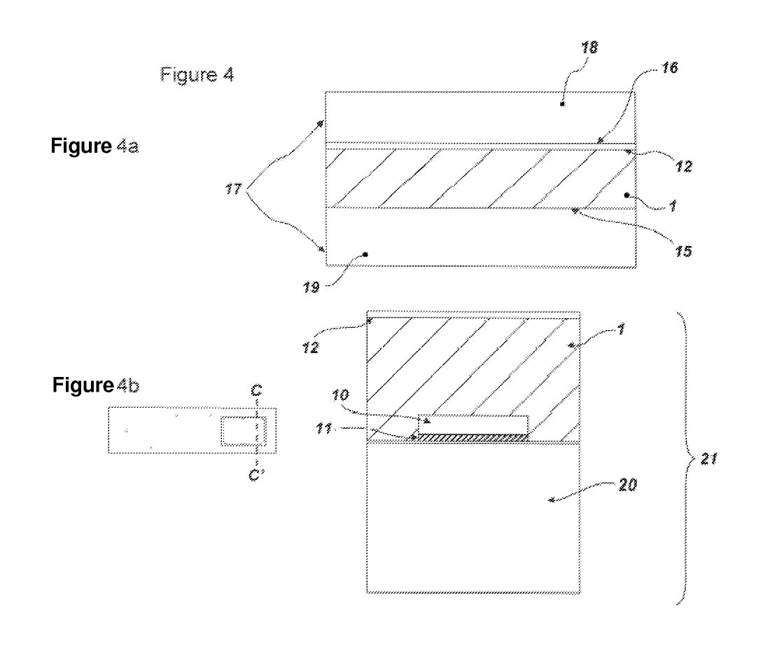

FIG. 4a is a schematic longitudinal sectional view of a device 17 for receiving the cartridge (substrate forming the main body of the cartridge 1) and allowing the actuation control 18 of the valves from the actuation face 16 of said cartridge and the fluidic injection 19 from the detection face 15 of said cartridge.

FIG. 4b is a cross-sectional view of the biochip according to the axis CC′, illustrated in the left insert. It shows the cartridge (and the biochip) resting on the contact imaging device 20 and forming an integrated biosensor 21.

The cartridge according to the present invention is adapted to the making of genetic molecular diagnostics for the detection of target molecular markers from a biological sample. It is then capable, after loading of the sample, to implement all the steps of the analysis chain.

Those steps comprise sample preparation and biomolecular recognition steps.

The preparation of the sample may include in particular, according to the methods, steps of cellular lysis, extraction of nucleic acids, amplification of certain of the nucleic acids, enzymatic digestion.

The biomolecular recognition comprises the link between the probe molecules and the target molecules and the identification of said link.

The cartridge according to the invention includes:

A substrate forming the main body 1 of the cartridge, including an actuation face 16, exemplified in FIG. 1 a, and a detection face 15, exemplified in FIG. 1b, which is opposite to it.

A fluidic circuit including a set of channels 2 and cavities, made in the substrate forming the main body 1 of the cartridge. Said cavities being likely to form the reaction chamber(s) 6 as well as the detection chamber 10. By detection chamber 10, it is to be understood herein a chamber or an area for the implementation of a biomolecular recognition process.

A set of microfluidic valves that control: the fluid flow within a same channel 2 formed in the vicinity of the actuation face 16 of the fluidic cartridge, as well as the inlets (injection) and outlets (evacuation) of fluids into and out of the cartridge. For that purpose, “U-shaped” or “in-line” valves might be used according to the embodiment.

The cartridge includes two opposite faces, whose functionalities are clearly distinct:

The face 16, known as the actuation face, includes the integrated valves seats 3, 5 and 14, the reaction chamber(s) 6 as well as the microfluidic channels 2 connecting them.

The opposite face 15, known as the detection face, includes the detection chamber 10. The access to the detection chamber 10 is obtained via holes 13 going through the main body 1 of the cartridge.

The fluidic injection is made from the detection face 15. The access to the fluidic circuit of the actuation face 16 is made via holes 13 going through the rigid substrate forming the main body 1 of the cartridge, perpendicularly to the actuation face 16 and the detection face 15. The end of these through-holes 13 forms orifices 4 opening in the detection face 15 or the actuation face 16 of the cartridge.

The invention will be better understood, and other characteristics, details and advantages will appear more clearly from the description of the embodiments proposed by way of illustration.

According to a preferred embodiment, the cartridge includes four parts assembled together:

This particular embodiment is described with reference to FIGS. 1 and 3a.

a. A main body, formed in a rigid substrate 1 including two opposite faces: the actuation face 16 (FIG. 1a) and the detection face 15 (FIG. 1b), these two faces being approximately parallel to each other.

The main body 1 of the cartridge is formed in a rigid substrate. This main body 1 may advantageously be made by injection molding of a thermoplastic polymer material such as the cyclic olefin copolymers (COC) or the cyclic olefin polymers (COP). The COC and COP are amorphous and transparent materials based on cyclic olefins, whose biocompatibility is excellent.

Generally, these materials must be biocompatible, transparent, and must allow the making of a sealed link with a diaphragm and/or adhesive patches. In particular, they may be chosen in the group comprising the polydimethyl-siloxane (PDMS), the polymethyl-methacrylate (PMMA), the polycarbonate, the polyacrylamide, the polyethylene, the polyvinyl chloride (PVC).

Preferably, the length and width dimensions of the cartridge are approximately those of a microscope slide, i.e. dimensions comprised between 65 and 85 mm long and 20 and 35 mm wide. The cartridge thickness is preferentially comprised between approximately 1 and 2 mm.

The actuation face 16 of the cartridge includes a certain number of recesses formed at the surface of the rigid substrate. These recesses define the valve seats 3, 5 and 14, the amplification reaction chamber 6 and the fluidic channels 2 connecting them.

The fluidic channels 2 connecting the various elements are parallel to the actuation face of the cartridge valves and are advantageously all located on this same face. These fluidic channels 2 parallel to the actuation face 16 are formed by grooves, the size is approximately 0.5 mm wide and 0.3 mm deep, formed at the surface of the actuation face 16 of the cartridge. These grooves are closed by the monolithic diaphragm 12.

Also advantageously, the valve seats 3, 5 and 14 are formed by a cylindrical recess, whose diameter is approximately of 4 mm and the depth of 0.1 mm, made at the surface of the actuation face 16 of the main body 1 of the cartridge formed in a rigid substrate. This recess includes an inlet orifice and an outlet orifice. These orifices correspond to an end of a fluidic channel 2 parallel to the actuation face and to the end or orifice 4 of a hole 13 going perpendicularly through to the cartridge.

The actuation face 16 of the cartridge also includes a nucleic acid amplification chamber 6. This amplification reaction chamber 6 is defined by a recess flush with the surface of the actuation face 16 of the cartridge, almost rectangular in shape, made at the surface of the actuation face 16 of the cartridge. The size of this amplification chamber 6 is of the order of 6 mm×4 mm×0.5 mm. Its capacity is approximately of 10 μL. The reaction chamber is generally connected by two microfluidic channels 2, parallel to the actuation face 16 and flush with said face 16.

The amplification of the nucleic acids allows multiplying the quantity of nucleic acids by a factor 10⁶ to 10⁸. It is then possible to detect target nucleic acids present in infinitesimal quantity (lower than 10 target molecules of nucleic acids, in theory only 1 copy is sufficient) in the starting sample. This thermal cycling is favored within the framework of a microsystem such as the cartridge of the present invention, by the small reaction volumes involved. It is possible to displace the reaction mixture between different temperature areas, circularly or in continuous flow. In the embodiment presently described, the amplification is performed by means of a PCR reaction (Polymerase Chain Reaction) within the reaction chamber 6, which may be physically isolated and thermally cycled. This technique requires the thermal cycling (generally between 50 and 95° C.) of a reaction mixture. The cartridge according to the present invention is preferentially intended to the detection, in parallel, of the presence of several molecular markers (at least 2 targets) within a biological sample. The choice of a multiplex amplification then allows performing, in a single reaction chamber, the amplification of several target molecules of nucleic acids.

b. A monolithic diaphragm 12 covering the actuation face 16 of the cartridge.

The diaphragm 12 covers the actuation face 16 of the cartridge. This monolithic diaphragm 12 is preferentially made in a material similar to the rigid substrate forming the main body 1 of the cartridge. Preferentially, the diaphragm 12 is a thermoplastic film of about 0.1 mm thick, bonded or welded to the surface of the actuation face 16 of the rigid substrate forming the main body 1 of the cartridge, by thermo-welding, bonding, adhesion or chemical link processes. This diaphragm 12 closes said actuation face 16 and allows the sealing of the microfluidic circuit. It cooperates with the grooves and the cavity formed by a recess, to form the channels and close the reaction chamber 6.

Advantageously, the diaphragm 12 is not only capable of resisting to heat, but also of transmitting it. It is therefore possible to contemplate that a heating system is placed directly opposite the area or chamber 6 for amplification of the nucleic acids, when the cartridge is placed in an automaton 17 for the control of the fluidic, 18 and 19, and thermal functions.

Still more advantageously, the diaphragm 12 is deformable. It thus cooperates with the valve seats 3, 5 and 14, made at the surface on the actuation face 16 of the cartridge, to form diaphragm valves at the level of said valve seats 3, 5 and 14. At rest, the diaphragm 12 is approximately planar and parallel to the actuation face 16 on which it is bonded or thermo-welded. The valves are thus open at rest. The actuation of these diaphragm valves is advantageously made by actuation devices, external to the cartridge, which allow deforming the diaphragm 12 opposite each valve seat 3, 5 and 14 and to block the valves.

The recess forming the valve seat 3 and 5 is interposed between a hole 13 going through the cartridge perpendicularly to the actuation face 16, which opens at the center thereof and forms an orifice 4 and a channel 2 parallel to the actuation face 16 and flush with the surface of the rigid substrate on the side of said face 16. This valve drawing is used similarly to the valves controlling the entrance and exit of fluid into and out of the cartridge and for the valves controlling in a binary way the flow within a same channel parallel to the actuation face 16. These latter valves are called “U-shaped valves”.

The deflection of the diaphragm 12 opposite the valve seat allows blocking the orifice 4 formed by the through-hole 13, whose diameter is far smaller than the recess formed by the valve seat 3 and 5. This device allows obtaining a maximal blocking of the cartridge while using a monolithic diaphragm 12 with a certain rigidity.

The accesses to the fluidic circuit, formed on the actuation face 16 of the cartridge, are made from the detection face 15, via through-holes 13. The deflection of the diaphragm 12 opposite the valve seats 3 or 5 allows blocking the orifices 4, formed by the ends of the through-holes 13 opening at the center of the valve seats 3 and 5, and thus stops the entrance and exit of fluid into and out of the cartridge.

In the case of the U-shaped valves, the channel 2 parallel to the actuation face 16 of the valves is offset to the detection face 15 by means of a through-hole, forms a parallel channel 8 offset to the detection face 15 of the biochip and is reinjected into the actuation face 16 by means of a through-hole 13 opening by an orifice 4 at the center of a valve seat 3 or 5.

c. Closing elements 9 cooperating with grooves, made at the surface of the detection face, to form the offset parallel channels 8 within the framework of the “U-shaped valves”.

The offset parallel channels 8 are formed by grooves made at the surface of the rigid substrate, forming the main body 1 of the cartridge, on the side of the detection face 16. The cartridge thus includes closing elements 9, preferentially adhesive dots (patches), to close these channels 8 and to seal them.

d. A biochip 11 closing the detection chamber 10 for the implementation of molecular hybridization process.

The detection chamber 10 consists in a recess formed at the surface of the rigid substrate, on the side of the face 15 opposite to the actuation face 16. The dimensions of the recess are of the order of 24 mm×24 mm×0.5 mm.

The detection chamber 10 integrates a biochip 11. This biochip 11 is advantageously bonded on the detection chamber 10, on the external side of the substrate forming the main body 1 of the cartridge, through a biochip seat (flange or shoulder formed in the recess, on the external side of the substrate). It thus closes the recess forming the detection chamber 10 and allows sealing said chamber.

The biochip 11 essentially includes a solid substrate, approximately planar, for example a glass, silicon or plastic slide, whose size is approximately 24 mm×24 mm×0.1 mm.

The surface of this substrate is chemically functionalized by techniques well known of the one skilled in the art, such as silanization or by deposition of nitrocellulose, polylysine, streptavidine, biotine, polypyrol. Said surface carries, after reaction, immobilized oligonucleotidic probes. The fixation of the probes may be performed in different manners well known by the one skilled in the art. It can be mentioned, for example, the chemical, electrochemical addressing, or the addressing based on the inkjet technology, implemented in printers. The probes are deposited according to a regular grid, by drops (spots) whose diameter is comprised between 10 and 1000 μm, preferentially 300 μm. Each drop thus corresponds to a specific affine area to be studied. The attachment of the target molecules is then spatially selective and makes a molecular recognition of the target molecules, by the knowing a priori of the composition of the probe molecules on which they are attached.

The access to the detection face 15 is made from the actuation face 16, via a hole 13 going perpendicularly through the rigid substrate from the actuation face 16 and forming an orifice 4 at the level of the chamber 10. The detection chamber 10 according to this embodiment also includes an evacuation allowing washing steps. Said evacuation is formed by an orifice 4 opening in said chamber and forming the end of a through-channel 13 and leading to a parallel channel 2 on the actuation face 16. This parallel channel 2 is then reinjected into the detection face 15 by a through-hole 13 for the evacuation.

In a second embodiment, the cartridge includes three parts assembled together:

a. A main body formed in a rigid substrate 1 including two approximately parallel faces (by “parallel” it is to be understood, within the framework of the invention, “approximately parallel”), the actuation face 16 and the detection face 15.

b. A diaphragm 12 covering the actuation face 16 of the cartridge.

c. A biochip 11 closing the detection chamber 10 and allowing the implementation of molecular hybridization process.

According to this embodiment, the main body 1 of the cartridge, formed in a rigid substrate, includes two types of valves:

the valves controlling the entrance or exit of fluid into or out of the cartridge,

the in-line valves for the binary control of the flowing within a channel.

The first type of valve is formed according to the above-mentioned principle. These valves are in particular formed in a valve seat 5, at the center of which opens an orifice 4 formed by a through-hole 13. The valve seat 5 consists in a cylindrical recess formed at the surface of the rigid substrate on the side of the actuation face 16.

The in-line valves allow the binary control of the flowing within a fluidic channel 2. The fluidic channels 2 are similar to those mentioned above. They are formed by grooves made parallel to the surface of the rigid substrate 1 on the side of the actuation face 16 of the cartridge and are closed by the monolithic diaphragm 12.

A fluidic channel 2 is interrupted by a valve seat 14 opposite which the diaphragm 12 may be deformed to stop the circulation of fluid. Said valve seat 14 is a cylindrical recess made at the surface of the rigid substrate on the side of the actuation face 16 of the cartridge and whose dimensions are approximately of 4 mm in diameter and 0.1 mm in thickness.

According to this second embodiment, the design of the cartridge is extremely simplified because it comprises only 3 elements assembled together. The set of microfluidic channels 2 is located on the actuation face 16, from which the fluid flowing control may be performed by one or several external actuation devices. The monolithic diaphragm 12 that covers said actuation face 16 is at the interface between the fluidic microcircuit and the device(s) for controlling the functions of the cartridge and for receiving 17 said cartridge. These functions include in particular the control of the fluidic flowing (control of the actuation 18 of the integrated valves of the cartridge and of the fluidic injection 19) and the control of the temperature of the reaction chambers or areas.

This simplicity also contributes to the robustness of the object that may be either disposed after each use, as necessary within the framework of human diagnostics tests, or reused after washing.

The detection of the biomolecular recognition is made by optical reading of the light emitted during the fixation of the target molecule on the probe, directly or indirectly after excitation by a suitable light. The present cartridge has two functionally differentiated faces: an actuation face 16 and a detection face 15.

Preferentially, the detection face is located on the lower face of the cartridge, so that said cartridge is capable of being read by a fluorescence reading device 20 of the contact imaging type, the whole forming an integrated biosensor 21. These aspects are illustrated in FIG. 4b.

According to this embodiment, the cartridge may then be placed into contact, by means of its detection face 15, with a fluorescence detector 20, for example en imaging device of the CCD or CMOS photo-detector matrix type.

The cartridge and fluorescence reading device unit then forms an extremely compact integrated biosensor.

Furthermore, this device allows maximizing the collect of the luminous emission of the fluorophores, the emitted light being directly picked up toward the medium with the highest index, i.e. toward the inside of the substrate of the biochip.

Advantageously, the substrate of the biochip 11 is then at least partially transparent at the wavelength of emission of the fluorophores used. It may reveal useful to free from the excitation light of the chromophores by using interferential filters or of other types, such as the colored filters, or a combination of filters of different types, highly rejecting the excitation light (of a value typically lower than 10⁻⁴ and, if possible, lower than 10⁻⁵), while ensuring a window of transmission for the radiation of the fluorophores.

Generally, it is desirable, for increasing the efficiency of collection of the light emitted by the chromophores, to use substrates having the highest possible refraction indices (as it is the case of a stack of dielectric layers of the Bragg mirror type), and this all the more since the measurements are performed in liquid phase because the refraction index of the medium is then of the order of 1.3.

According to the physical optics laws, it is also possible to create a double resonance, in such a manner to obtain a reinforcement of the light collected and of the excitation. The first resonance relates to the wavelength of emission and the second the wavelength of excitation. This double resonance is obtained by a determination of the coincidence between the antinodes of the electric field for the two emission and excitation wavelengths.

An interferential filter (of the Bragg mirror type) or a filter of rejection of the wavelength of excitation of the fluorophores, transparent at the wavelength of emission of the fluorophores, may be interposed between the substrate and the sensor, or directly constitute the substrate. Advantageously, this filter comprises an absorbing filter or a reflective filter, as described in particular in the prior application WO 2007/04575, incorporated herein by way of reference. These filters allow benefiting from an amplification of the light of excitation of the markers by an effect of constructive interference and also an amplification of the light emitted by the markers. These filters are also strongly rejective of the excitation light (of a value typically lower than 10⁻⁴, and if possible lower than 10⁻⁵), while ensuring a window of transmission for the radiation of the chromophores. In practice, the ratio of the transmittances of the wavelengths of emission and excitation of the markers is of at least 10⁵. A reflective means or a so-called “near” mirror, placed at a distance (d) of the chromophores such that said reflector ensures an effect of interference allowing an amplification of collection of the light emitted in the support (d verifying the relation: d<nλ/2NA2, where NA is the numerical aperture of the objective of collection of the light emitted by the chromophores according to the wavelength (λ) and “n” is the index of the medium between the mirror and the chromophores), and coupled to exciting waves arriving on the chromophores under any incidence with respect to the normal to the support. A non-zero incidence ensures as a complement a reinforcement of the excitation when a double resonance exists, i.e. a coincidence between the antinodes of the field for the two wavelengths of excitation (λexc) and of emission (λemit). The detection remains centered to the normal to the support.

Such variants of the composition of the substrate of the biochip 11 are also described in the application WO 2010/000757, incorporated herein by way of reference.

The biochip 11 may also integrate structures producing guided waves having an evanescent part, to excite fluorophores likely to be immobilized on a biochip substrate. The evanescent wave excitation biochips are particularly interesting in a system for collection of the contact fluorescence image, where it is searched to avoid the direct illumination of the sensor 20 (which must then be protected by a wavelength-selective filter eliminating the excitation light). The evanescent waves thus allow avoiding exciting any element, on the optical path, likely to increase the fluorescence background.

It may be used, as a source of the guided waves, the fluorescence emission or the injection by the edge or any other means for coupling the excitation light in the biochip 11. Such means for exciting the fluorophores are described in particular in the application WO 02/16912 A1, incorporated by way of reference. For that purpose, the substrate of the biochip may comprise a guiding layer having a higher index than that of the surrounding layer and whose upper face is very close to the chromophores at the scale of the evanescence wavelength of the guide wave.

The cartridge according to the invention allows in particular implementing the following method, in which the performance of the analysis may consist of a succession of extraction, purification, amplification, hybridization and detection operations.

a. After collection of the sample, the latter might be subjected to a lysis step outside the system, for example thanks to a lysis solution to which are added magnetic beads that fix the nucleic acids.

To implement the next steps of the analysis, which are performed within the cartridge, said cartridge has to be inserted into one or several devices 17 and 20 for receiving the cartridge, allowing in particular the control of injection and fluidic circulation 17 and the thermal control of the amplification and hybridization chambers as well as the optical reading 20.

It is possible to refer by way of illustration to the following steps, in FIG. 1 a or 2a, in which the valves A and D and E and H are valves allowing the binary control of the fluid flowing within a parallel channel.

The valve B/F is a valve allowing the fluidic injection into the cartridge.

The valve C/G is a valve allowing the flowing of fluids outside the cartridge.

b. The lysed sample is then injected into the cartridge through a sample injection orifice 7. The valves NE and C/G being open and the valves B/F and D/H being closed.

c. In case of extraction of the nucleic acids by magnetic beads, a magnet placed in the cartridge receiving device, opposite the DNA extraction area, allows retaining the magnetic beads.

d. Different washings are then applied, during which only the valves B/F and C/G allowing the fluidic injection and the flowing of fluid out of the cartridge are open.

e. The reaction mixture is injected. An multiplexed amplification is performed in the amplification chamber 6, which is subjected to a thermal cycling. During this operation, all the valves are closed, so as to isolate the chamber 6 from the outside.

f. Once this PCR executed, the content of the chamber 6 is transferred into the hybridization chamber 10 by opening the related valves. For that purpose, a fluid is injected through the valve B/F, so as to push the amplified mixture, and the valve D/H is open so as to permit the transfer toward the detection chamber 10.

g. During the hybridization procedure, the target molecules hybridize with the probes deposited on the biochip 11. This reaction may be accelerated by a to and fro stirring controlled by the cartridge receiving device. All the valves are closed. It is to be noted that the orifice 4 for the evacuation of fluids out of the microfluidic cartridge is not controlled by a valve. According to the principles of fluid flowing in microfluidic circuits, the closing of the valve D upstream the detection chamber permits to stop the flowing out of said detection chamber 10. At the end of this step (or during the latter), the detection by excitation/collection occurs, so as to reveal which targets have been hybridized.

h. The biochip 11 might be washed and subjected to steps of development, before detection, the valves B/F and D/G are then open.

Therefore, the cartridge allows the simplified implementation of a complete method of molecular diagnostics in optimized economic conditions.

1. A cartridge for performing a method of analysis of nucleic acids comprised in a sample, comprising a main body (1) made in a substrate, in which are formed:
at least one reaction chamber (6) and one chamber (10) for the detection of at least one nucleic acid likely to be contained in the sample,
a microfluidic circuit including a means (7) for injection of the sample, means (13 and 4) for injection and evacuation of fluids into and out of the cartridge, cavities, fluidic channels (2) and valves capable of blocking these latter,
characterized in that said cartridge comprises (a) a first face (16), known as the actuation face, from which the actuation of the cartridge valves is possible, and (b) a second face (15), opposite to said actuation face (16), including the chamber (10) for the detection of at least one nucleic acid likely to be contained in the sample, known as the detection face (15).

2. The cartridge according to claim 1, characterized in that the valves are formed by a deformable diaphragm (12) placed opposite a valve seat (3 or 5 or 14), said valve seat (3 or 5 or 14) comprising at least one inlet orifice and one outlet orifice of said valve seat (3 or 5 or 14).

3. The cartridge according to claim 2, characterized in that the valve seats (3 or 5 or 14) are formed by recesses made at the surface of the actuation face (16) of the main body (1) of the cartridge.

4. The cartridge according to claim 3, characterized in that the surface of the deformable diaphragm 12 placed opposite the valve seats (3 or 5 or 14) is, at rest, approximately planar and parallel to the actuation face of the cartridge and capable of being deformed by an outer actuator.

5. The cartridge according to claim 1, characterized in that it includes fluidic channels (2) made in the substrate forming the main body (1) of the cartridge in the vicinity of each of the actuation face (16) and detection face (15), and holes (13) going through said substrate and connecting said two faces with each other.

6. The cartridge according to claim 5, characterized in that the fluidic channels (2) located in the vicinity of the actuation face (16) and detection face (15) of the cartridge are formed by grooves flush with the surfaces of the substrate forming the main body (1) of the cartridge on the side of the actuation face (16) or of the detection face (15) of the cartridge, and are closed by closing elements (9).

7. The cartridge according to claim 5, characterized in that it allows the injection of the sample as well as the injection of fluids into the cartridge and the evacuation of fluids out of said cartridge, from the detection face (15) of the cartridge.

8. The cartridge according to claim 7, characterized in that the injection of fluids into the cartridge and the evacuation of fluids out of said cartridge are controlled by valves of the cartridge, said valves including at least:
one inlet or outlet orifice (4) opening at the center of the valve seat (5), said orifice (4) being formed by an end of a hole (13) going through the substrate forming the main body (1) of the cartridge, perpendicularly to the actuation face (16), and
one outlet or inlet orifice formed by an end of a fluidic channel (2) formed in the vicinity of the actuation face (16) of the cartridge.

9. The cartridge according to claim 6, characterized in that the circulation of fluid within a fluidic channel (2) formed in the vicinity of the actuation face (16) of the cartridge in stopped by means of a U-shaped valve,
said channel (2) being offset to the detection face, by means of a hole (13) going perpendicularly to the actuation face (16) through the substrate forming the main body (1) of the cartridge, and being then reinjected into the actuation face (16) by means of a second through-hole (13), whose end on the side of the actuation face (16) forms an orifice (4) opening at the center of a valve seat (3) opposite which a deformable diaphragm (12) is likely to be deformed.

10. The cartridge according to claim 6, characterized in that the circulation of fluid within a channel (2) located in the vicinity of the actuation face is stopped by means of an in-line valve,
said channel (2) being stopped by a valve seat (14), opposite which a deformable diaphragm (12) is likely to be deformed.

11. The cartridge according to claim 10, characterized in that all the fluidic channels (2) are located on the actuation face (16).

12. The cartridge according to claim 8, characterized in that the elements (9) closing the grooves formed on the face opposite to the actuation face (16) are adhesive patches.

13. The cartridge according to claim 1, characterized in that the reaction chamber(s) (6) is/are one/several recess(es), each flush with one of the surfaces of the substrate forming the main body (1) of the cartridge on the side of the actuation and/or detection faces of said cartridge, said recesses being closed by a closing element (9).

14. The cartridge according to claim 1, characterized in that it includes at least one reaction chamber (6) for the amplification of nucleic acids.

15. The cartridge according to claim 13, characterized in that the reaction chamber(s) (6) is/are formed at the surface of the substrate forming the main body (1) of the cartridge on the side of the actuation face (16) of said cartridge.

16. The cartridge according to claim 1, characterized in that it includes a monolithic diaphragm (12), covering all or part of the surface of the substrate forming the main body of the cartridge on the side of the actuation face (16) of said cartridge and cooperating with said surface to form channels parallel to said face (16) at the grooves formed on said surface and at least one reaction chamber (6) at the cavity(ies) formed on said actuation face (16).

17. The cartridge according to claim 16, characterized in that the monolithic diaphragm (12) covering the fluidic face is capable of resisting to the heat and of transmitting said heat.

18. The cartridge according to claim 16, characterized in that the monolithic diaphragm (12) is a deformable diaphragm, cooperating with said face to form diaphragm valves, opposite the valve seats (3 or 5 or 14), said diaphragm (12) being capable of being deformed under the action of an external actuator placed opposite the valve seats (3 or 5 or 14).

19. The cartridge according to claim 1, characterized in that the nucleic acid detection chamber (10) is formed by a recess formed at the surface of the substrate of the cartridge on the side of the detection face (15) and includes a biochip (11).

20. The cartridge according to claim 19, characterized in that the detection chamber (10) is closed on the external side of the substrate of the cartridge by the biochip (11).

21. The cartridge according to claim 19, characterized in that the substrate of the biochip (11) is likely to comprise fluorescent substances immobilized at its surface, which absorb the light at a first, excitation wavelength and which emit light at a second, emission wavelength, said substrate comprising means for increasing the efficiency of the emission light quantity related to the excitation light quantity.

22. The cartridge according to claim 1, characterized in that said cartridge is disposable.
